(19) United States
(12) Patent Application Publication
(10) Pub. No.: US 2011/0214237 A1
(43) Pub. Date: Sep. 8, 2011

(54) Split apart soft stretcher

(76) Inventors: James Charles Boudreau, Hales Corders, WI (US); Thomas Richard Stuckart, Muskego, WI (US)

(21) Appl. No.: 12/660,944

(22) Filed: Mar. 8, 2010

(51) Int. Cl. A61G 1/013

(52) U.S. Cl. 5/627

(57) ABSTRACT

One embodiment of this patient transferring device is that it remains flexible. This flexible, split apart stretcher provides a way to convey patients from one location to another. This application has flexible rubber tubing 22 for a frame to help the materials used keep its shape while remaining flexible. This application provides reliable handgrip openings 20 that allow users to hold directly onto the rubber tubing frame 22 sewn into the lateral edges. This application utilizes a low density polyethylene center spline 14 that gets inserted through alternating loopholes 16 off of the left 10 and the right 12 sides of the application. The center spline 14 going through the alternating loopholes 16 allow for this application to be split apart and removed from under a patient. Removal of this application is done by withdrawing the center spline 14 from the loopholes 16 and pulling both the left 10 and the right 12 sides of the application out from its respective side. This application requires very little assistance from the patient during removal.

### CROSS-REFERENCE TO RELATED APPLICATIONS

Not Applicable

### Federally Sponsored Research

Not Applicable

### SEQUENCE LISTING OR PROGRAM

Not Applicable

### BACKGROUND OF THE INVENTION

1. Field of Invention

This Application relates generally to the medical transport systems, more specifically to patient lifting and patient transferring devices used by Emergency Medical Technicians (EMT's), Paramedics, Firefighters, hospital workers, nursing homes and surgical centers.

2. Discussion of Prior Art

Previous lifting and transferring of patients in the medical field that do not require spinal immobilization are done by the usage of various types of maneuvers or devices. Hand carries and/or usage of blankets are some of the current methods used to transfer patients from one location to another. The other way is to use rigid backboards or stretchers with rigid, metal frames that are not flexible for patients that do require spinal immobilization.

Hand carrying techniques of patients do not provide a uniform lift of the patient. They also do not provide appropriate hand grips to hold onto the patient. Hand carrying techniques also do not provide the ability to limit the movement of the patient during transport. Hand carries require the carriers to lift the patient using various lifting points of a patient's body that may require the patient to be carried in a position of discomfort causing undue pain or pressure. These lifting techniques also require the carriers to hold onto the patient's body or clothing instead of adequate hand grips.

An example of a hand carry would be where one carrier is behind the torso of the patient with their arms under the patient's armpits and another carrier is holding under the patient's knees. This example and other types of lifting and transferring techniques of a patient do not provide an easy and safe way for the patient to be carried for distance safely and effectively without either putting the carriers or the patient in harms way. These techniques do not provide adequate handgrips to hold onto the patient while transferring or conveying to an awaiting gurney or cot.

The use of blankets is another way of patient lifting and transferring. One of the problems with the use of blankets is their ability to bear the weight of the patient. Blankets are frequently laundered. This laundering process will eventually break down the material of the blanket. The use of these blankets will then become unsafe for the bearing of the patients weight. The use of blankets do not allow for easy removal from under the patient without a lot of required patient movement or rolling from side to side, potentially causing discomfort or pain in the patient. Blankets also impose a problem by not providing adequate hand grips to effectively be able to hold onto while transferring the patient from one location to another. They require the carriers to uncover the patient and expose them while the carriers either roll a portion of the blanket up to hold onto in their hands or just grab whatever they can in their hands by bunching up the blanket. Blankets can provide a more uniform lift than hand carries, but as stated before they are frequently laundered and become tattered overtime which deteriorates the condition and reliability of the blanket to adequately lift and transfer the patient.

Pre-hospital and hospital blankets are usually made of cotton material which does not provide abrasion, scuff or tear resistance. Blankets also are not made of water resistant material to resist contaminated fluids from impregnating the lifting and transferring device. Therefore each time you use a blanket; it should be laundered and decontaminated for next use. This will eventually deteriorate the blanket.

These types of lifting and transferring techniques also require the workers to get in extremely close contact with patient's that may be contaminated or contagious. This bodily contact between the patient's and their carriers is a risk that could be easily avoided if the carriers were using an adjunct that wouldn't require the same bodily contact as hand carries or the usage of blankets.

The final two types of lifting and transferring techniques and devices used for patients are the use of rigid, non flexible, composite stretchers. The frame or device that surrounds this type of stretcher does not have the ability to remain flexible. These may be useful in an open area to transfer or transport a patient. These stretchers do not provide the same ability to operate in confined areas like this application. An example of a confined area would be a hallway where space may be limited and patient transport requires the carriers to operate around corners within a patient's home. These stretchers or backboards are also commonly referred to by emergency medical professionals as a backboard. The rigid framing materials used by these stretchers limit their versatility and maneuverability. Our application always remains flexible. Our application also possesses the ability to maneuver in confined areas due to its rubber tubing frame that is sewn into this application.

None of the current techniques used in this field previously will be able to provide the advantages of one or more aspects of this application. Thus, the need for this application is apparent to provide a safe, effective way to lift and transfer patients from one location to the other. The advantages and needs of one or more embodiments of this application in this field will become more apparent to the reader in the following sections.

One of the advantages of one or more aspects of this application is to provide a uniform lift of the patient. Another advantage of one or more aspects of this application is to provide adequate hand grips for carriers to hold on to during usage. Another advantage of one or more aspects of this application is to provide the flexibility for this application to be used in the many different positions of patient transportation. Patient transporting devices such as gurneys can place the patients head in elevated positions with multiple stopping points from horizontal to 90° upright. These transporting devices can also place the patients' feet in an elevated position up to 30° upright either by themselves or with the head elevated in conjunction with them. The flexibility of this application allows for it to conform to the position of the stretcher or gurney that it is being used on. Another advantage of one or more aspects of this application is to have a removable center spline.

This allows for this application to split into two parts for removal of this application from each respective side of the patient without excessive movement once the patient is placed where they need to be. Another advantage of one or more aspects of this application is to have a removable center spline made of Low density polyethylene that is as flexible as the rest of the material of this application. Another advantage of one or more aspects of this application is to be made of coated water resistant material for easy decontamination. Another advantage of one or more aspects of this application is to be made of material that is abrasion, scuff, tear and rip resistant material. Another advantage of one or more aspects is to be constructed of light weight construction. These and other advantages of one or more aspects will become apparent from a consideration of the ensuing summary, description and accompanying drawings.

### SUMMARY

The need for an application that can transfer a patient in a safe and effective way is prevalent in today's medical field. This application is a flexible stretcher that splits into two halves. This application would be used in areas where patient transport or transfer is required from one location to another with minimal patient movement given or required by the patient. This application is constructed of a lightweight durable fabric that is coated to make it water resistant. The fabric of this application also has qualities such as abrasion, scuff and tear resistance.

If this application needs to be recovered by personnel after transfer of transport, this application has a flexible spline that is removable from the head or foot end of the stretcher. This removable spline allows for the application to split into two halves equally. Each half then can be removed from its respective side of the patient without the patient having to move or roll to one side or the other. The center spline in this application is placed in between alternating loops that are sewn into the medial edges of both halves of this application. This allows for the two halves of this application to be held or linked together by the center spline through the alternating loops of each half while transferring or transporting a patient until the need for removal is present.

The low-density polyethylene center spline remains flexible and also has the ability to conform to the contour of a patient or stretcher. This application also has the capabilities of providing a uniform lift for the patient by using the handgrip openings. The fabric of this application will remain flexible and contour the patient's body and lift equally.

This application also allows for the users to have adequate hand grips to hold onto in conjunction with the two lateral edges of each half having rubber tubing sewn into the fabric for stability. The handgrip openings along the lateral edges of this application allow for the users to place their hands through openings that are strategically placed to distribute the patient's weight evenly. These handgrip openings allow for the users to hold onto the rubber tubing sewn into the fabric in the palm of their hands for a firm grip. The rubber tubing within the fabric of this application allows for the application to have a flexible frame.

Once at a destination where the application needs to be removed from under the patient, the user would simply hold onto the handle of the center spline near the patient's feet and pull the spline away from the patient. This removes the center spline from the alternating loopholes of each half and allows this application to be removed from each side of the patient with limited movement. There is nothing else conjoining this application other than the center spline. This application can then be easily reassembled for another use after it is removed from under the patient.

### DRAWINGS

### Figures

In the drawings, closely related figures have the same number but different alphabetic suffixes.

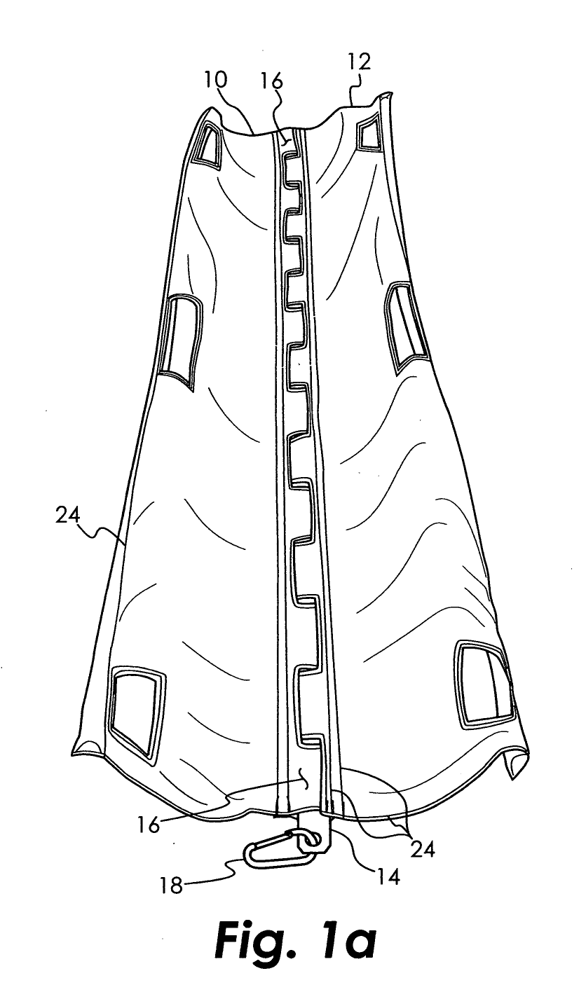

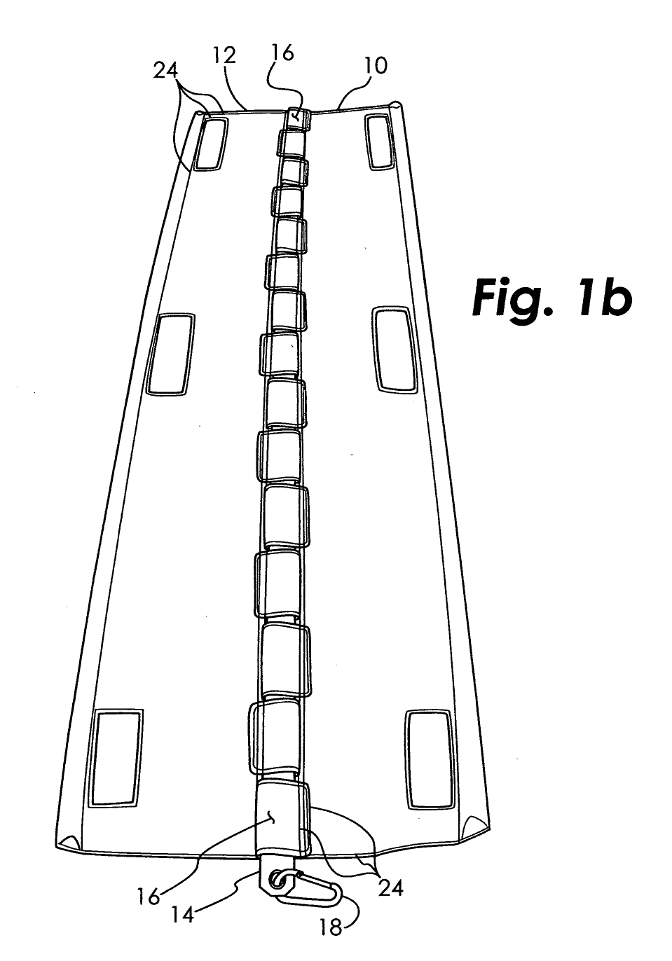

FIG. 1a shows a top view aspect of this application assembled in accordance to one embodiment.

FIG. 1b shows a bottom view aspect of this application assembled in accordance to another embodiment.

FIG. 1c shows the center spline removed from this application in an exploded view in accordance to another embodiment.

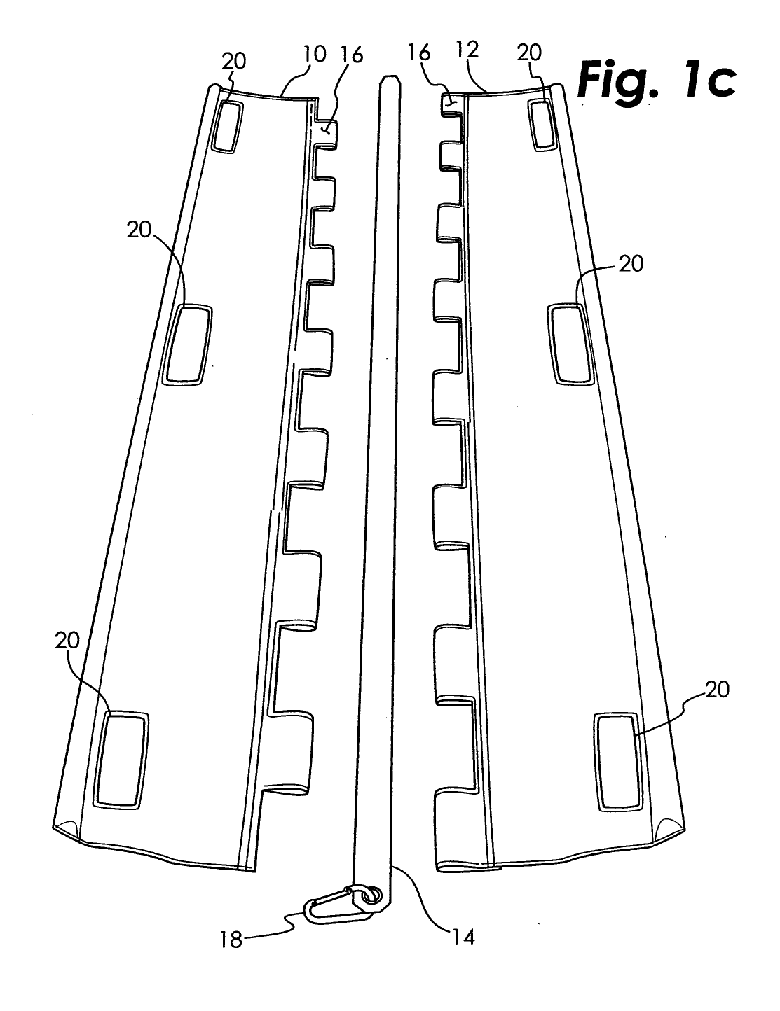

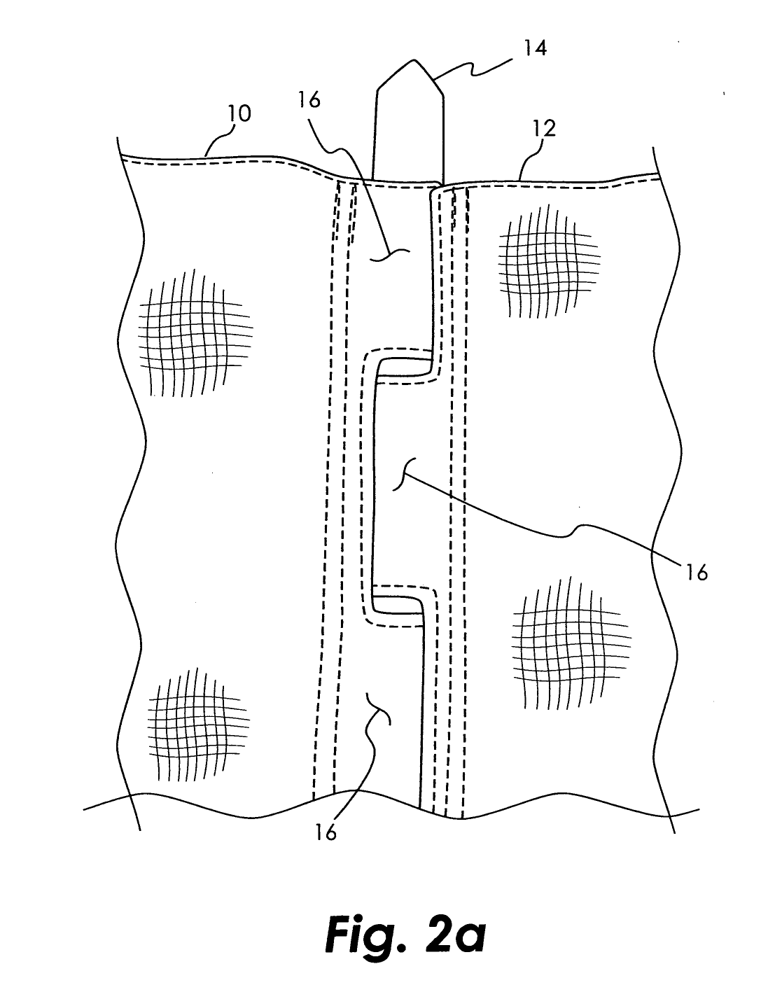

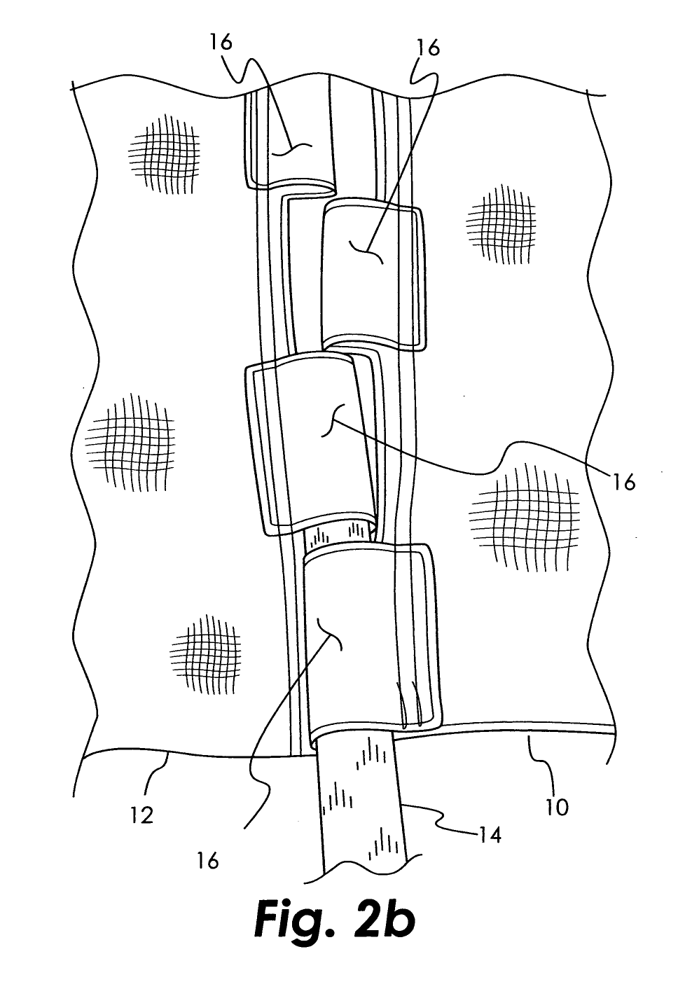

FIG. 2a shows the loopholes in a top view aspect of this application in accordance to another embodiment.

FIG. 2b shows the loopholes in a bottom view aspect of this application in accordance to another embodiment.

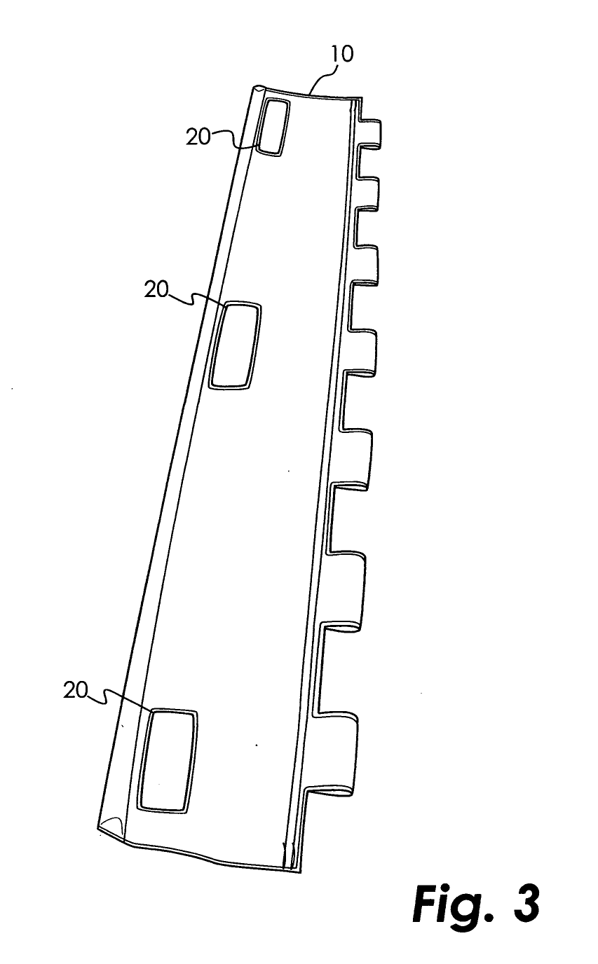

FIG. 3 shows one of the two halves of this application in accordance to another embodiment.

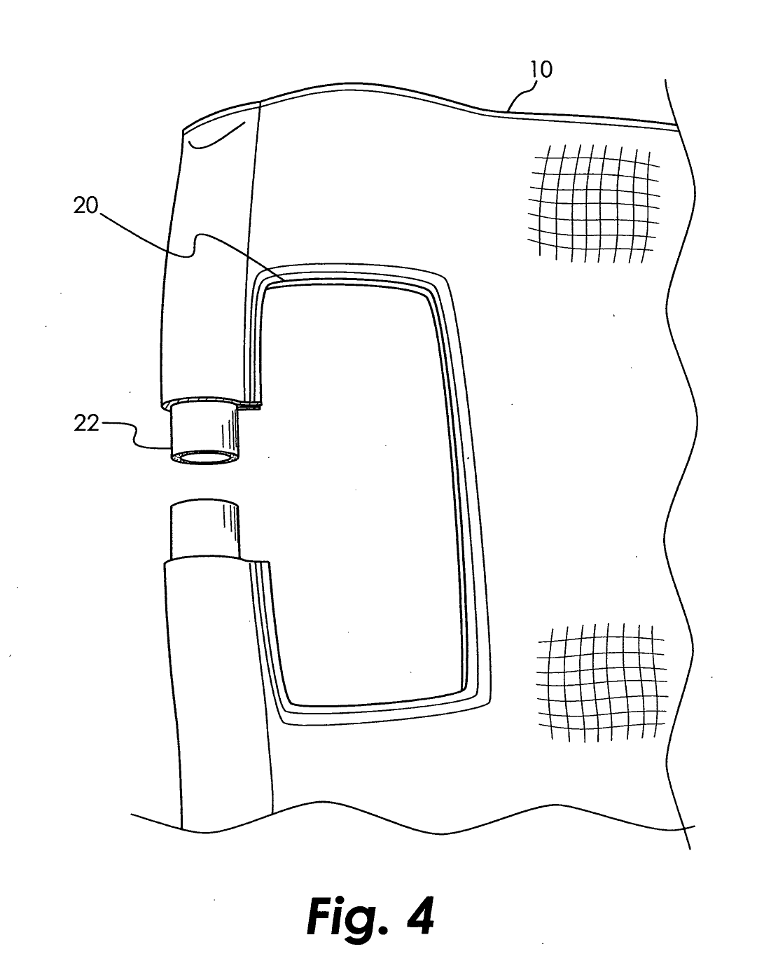

FIG. 4 shows the detailed description of the handgrips and sewn in tubing in accordance to another embodiment.

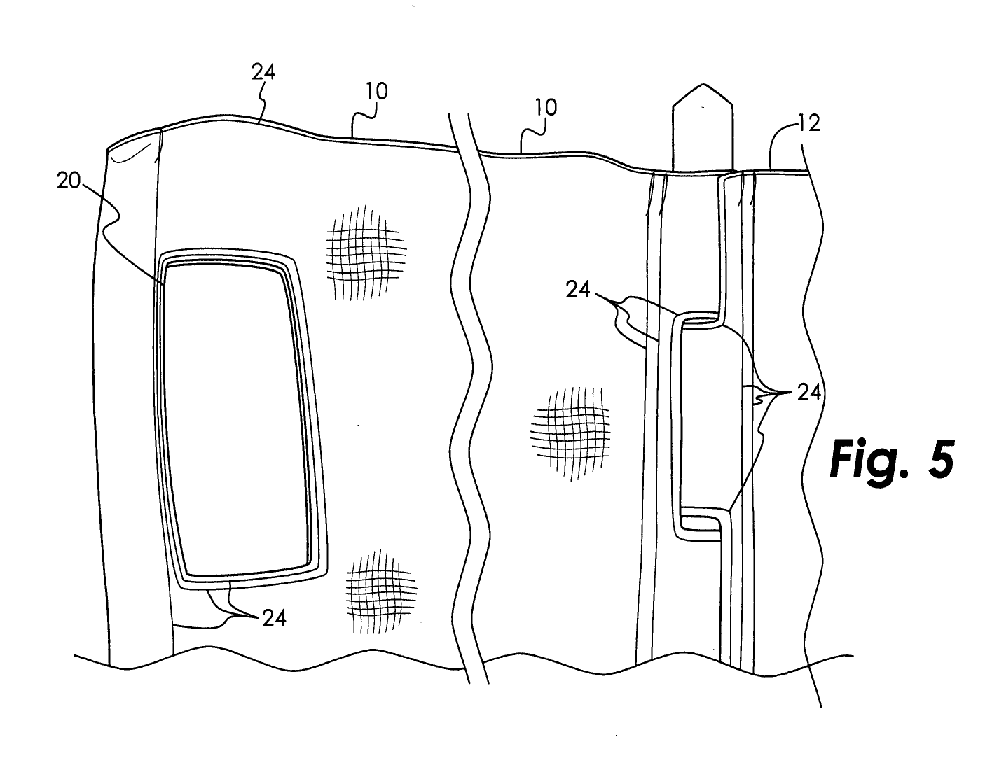

FIG. 5 shows the detailed stitching used in this application in accordance to another embodiment.

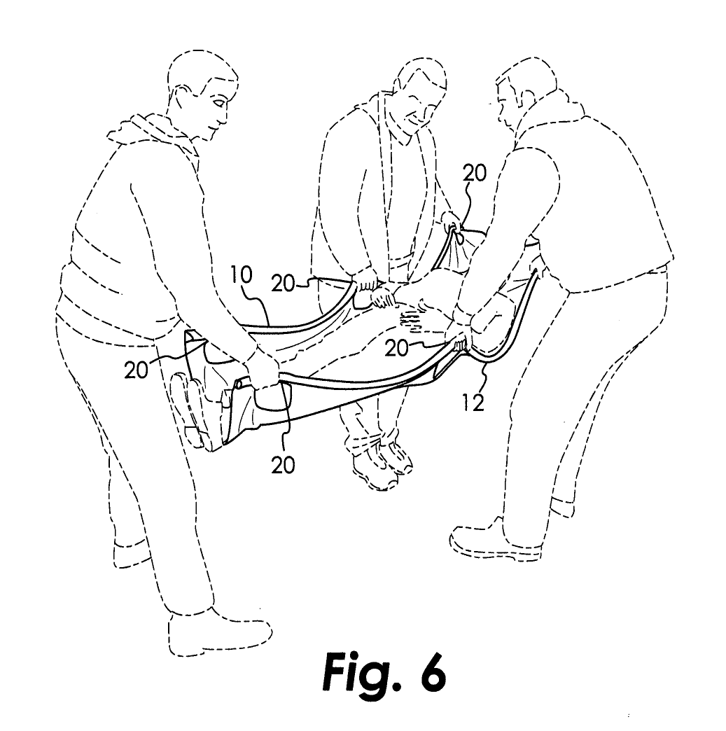

FIG. 6 demonstrates the ability to perform a uniform lift of a patient in accordance to another embodiment.

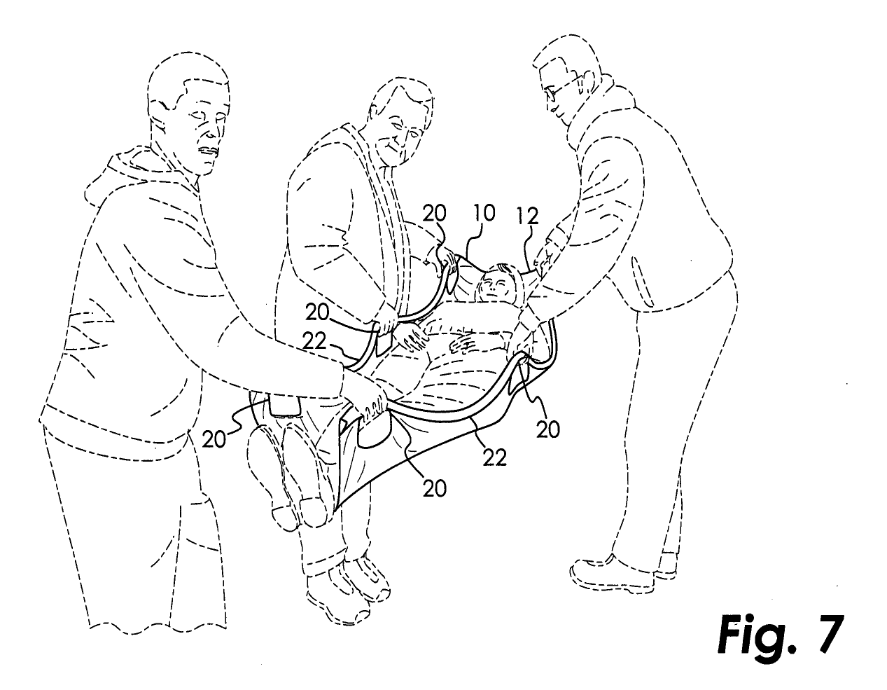

FIG. 7 demonstrates the use of the handgrip openings with the sewn in rubber tubing frame in the in accordance to another embodiment.

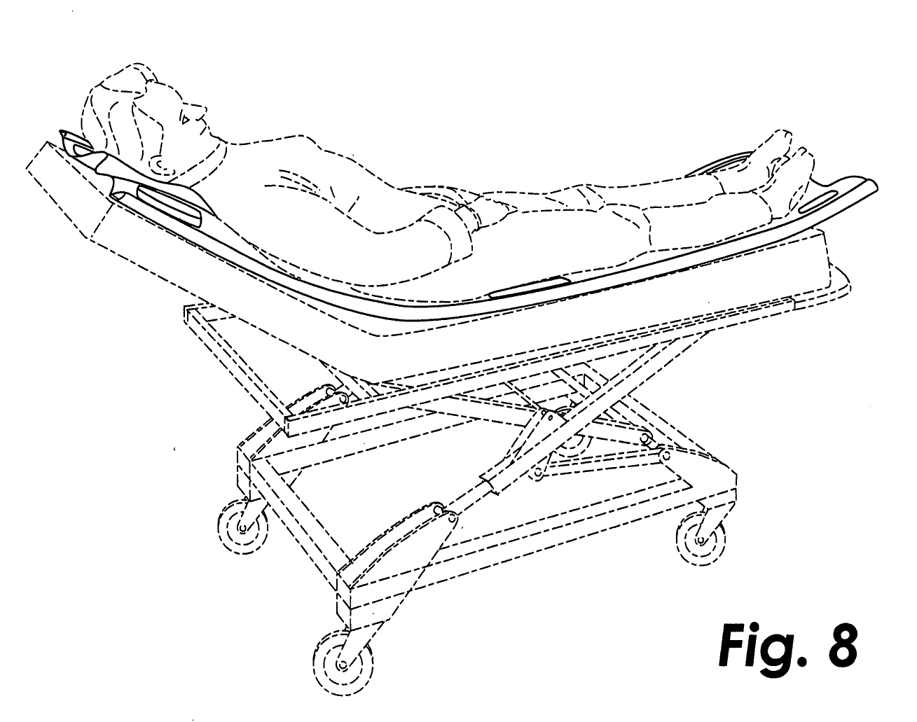

FIG. 8 demonstrates the flexibility of this application in accordance to another embodiment.

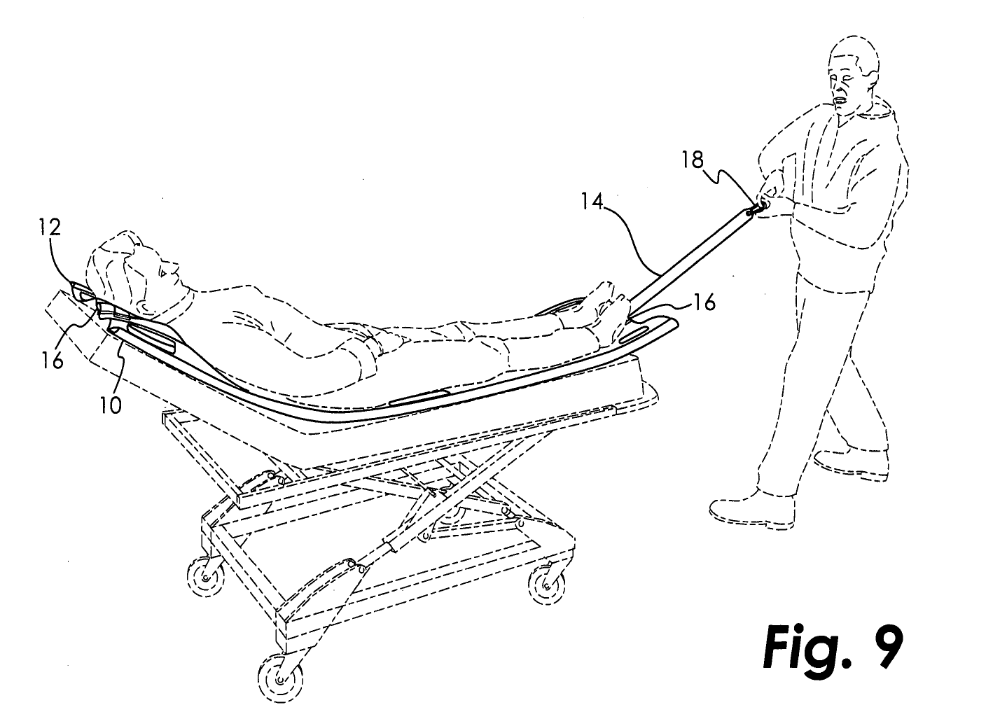

FIG. 9 demonstrates the removal of the low-density polyethylene center spline using the center spline handle in accordance to another embodiment.

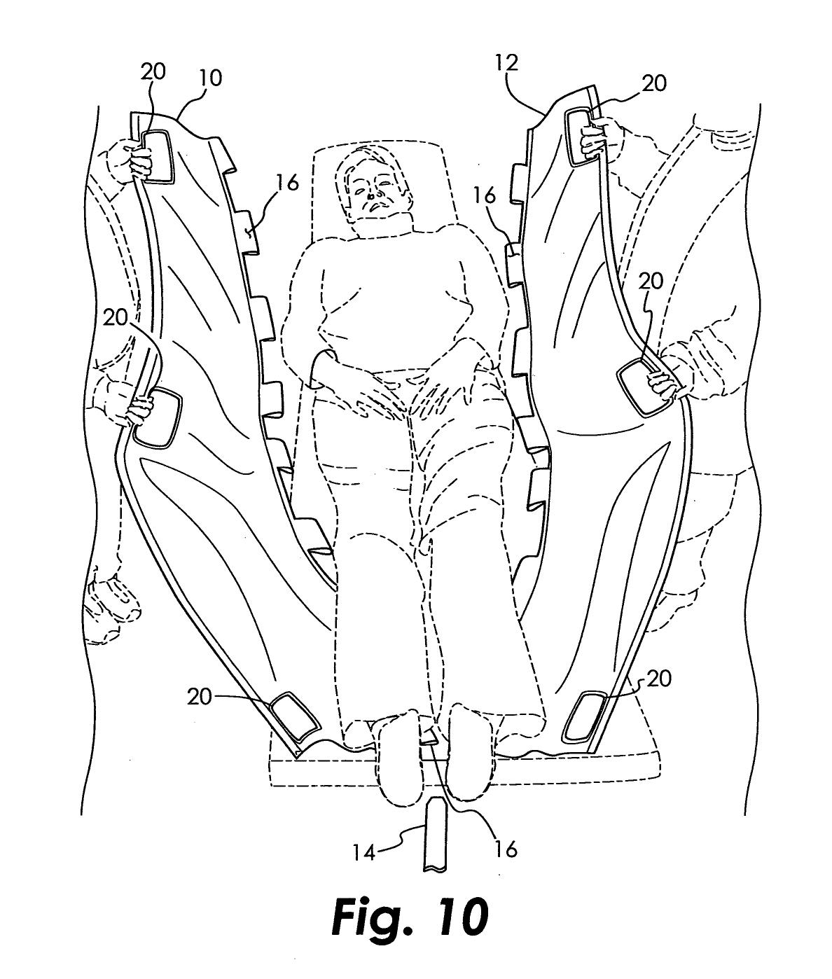

FIG. 10 demonstrates the removal of each half from under a patient after the center spline has been removed in accordance to another embodiment.

### REFERENCE NUMERALS

In the drawings, parts of the application will be marked with the following reference numerals.
10 left side of this application
12 Right side of this application
14 Center spline
16 Loopholes
18 Center spline handle
20 Handgrip openings
22 Flexible tubing
24 Stitching

### DETAILED DESCRIPTION

### First Embodiment—FIGS. 1a-1c, 2a-2c, 3, 4 and 5

One embodiment of this application is illustrated in FIGS. 1a-1c. FIG. 1a (top view), FIG. 1b (bottom view) and FIG. 1c (exploded view), show how the application has three main components: The Left Side 10, the Right Side 12 and the center spline 14. In FIGS. 1a-1c, the Left Side 10 of the application and the Right Side 12 of the application are made of the lightweight, abrasion, scuff and tear resistant material known as 1000 Denier Cordura® fabric. This material is the 1000 denier coated Cordura® fabric that is coated and water-resistant. Each left 10 and right 12 side is constructed of two layers of the Cordura® fabric that is sewn together into a single pattern. The third component of the application that can be seen in FIGS. 1a-1c is the center spline 14. The center spline 14 is made of flexible Low-density polyethylene (LDPE). The center spline 14 connects both the left side 10 and the right side 12 together by being placed through the loopholes 16 sewn on each side using a nylon thread for stitching 24. The center spline 14 also has a center spline handle 18. This will give the user a handle to hold onto for center spline 14 removal. The center spline handle 18 will consist of a medium duty carabineer.

As shown in FIG. 1c (exploded view), the loopholes 16 are offset with one another from the opposite side so that when the left side 10 and right side 12 are together, the center spline 14 alternates going through the loopholes 16 from each left 10 and right 12 side. This configuration will lock both sides 10 and 12 together when this application is put together.

In FIGS. 2a-2b are illustrations showing the detailed description of the loopholes 16 that the center spline 14 passes through. The center spline 14 alternates passing through a loophole 16 from each side of the stretcher holding the left side 10 and the right side 12 together (FIG. 1a). In FIG. 2a the equally sized tabs that are originally sewn in the fabric pattern are then folded over to the bottom side of the application as seen in FIG. 2b and sewn into the fabric forming a sewn loophole 16 for the center spline 14 to pass through.

In FIG. 3 is a close up of the left side 10 of this application. This view is to describe the lateral aspect of this half of the application. This will enable the reviewer to get a more detailed view of this application. FIG. 4 is a close up of the lateral edge with one handgrip opening 20 shown. In FIG. 3 (top view) and FIG. 4 (close up), the lateral edges have a sewn in flexible rubber tubing 22. This rubber tubing 22 forms the edge of the application while remaining flexible for usage. The rubber tubing 22 also gives stability in the fabric to maintain its shape and provide a flexible rubber frame for this application. This rubber tubing 22 also provides a handle to grip in the palm of the users hand with their fingers going the handgrip openings 20.

Shown in FIG. 3 and FIG. 4, is that immediately to the inside of the lateral edges of each half 10 and 12 of this application, are strategically located handgrip openings 20. These handgrip openings 20 allow for the users to hold onto the sewn in rubber tubing 22 while passing their fingers through the handgrip openings 20 to be able to completely get their hands around the tubing 22.

FIG. 5 shows the reinforced nylon stitching 24 used in this application. This nylon stitching fastens the two pieces of fabric together that comprises each left 10 and right 12 sides. This stitch pattern is also back stitched at the corners and edges to reinforce and lock the stitching 24 in those areas where the stitch line originated or ended.

### DETAILED OPERATION

### First Embodiment—FIGS. 6, 7, 8, 9, 10

The movement of a patient or a person with this application is best described in the following detailed operation. The following figures will go through the intended use and operation of this application. It will also cover the use of the handgrip openings, the flexible rubber tubing edge/framing, the removal of the center spline and the removal of this application from under the patient.

This applications uniform lifting capabilities is shown in FIG. 6. In FIG. 6 you will see how the patient is placed on the application and is ready for movement by the three users of the application. The patient is placed in a centered location on the application for equal weight distribution. FIG. 6 also shows how the three users are correctly located around the application. One user is on the left side 10 using the two handgrip openings 20, and a second user is located on the right side 12 of the application using their own two handgrip openings 20. A third user is using the bottom two handgrip openings 20 located on the foot end of both the left 10 and the right side 12. Having the handgrips 20 located in areas of the head, waist and feet of the patient, it equally distributes the weight of the patient and provides the uniform lift needed to convey the patient to an awaiting location.

FIG. 7 shows the proper use and operation of the handgrip openings 20. These handgrip openings 20 allow for the users to place their hands through the sewn rectangular holes along the lateral edges. These openings 20 allow for the users to grab a hold of the flexible tubing 22 sewn into the lateral edges of both the left side 10 and the right side 12. This flexible rubber tubing 22 provides the strength to support the weight of the patient and providing an adequate place to hold onto without obstructions. Each user of this application may use one or more handgrip openings 20 to hold on to providing there are enough users to support and move the patient's weight. Since a patients weight is variable from one to another, it may be necessary to have anywhere from two to six users to transfer the patient with this application.

FIG. 8 shows how this applications operation remains flexible while on a stretcher or gurney. The physical characteristics of the application allow for it to bend and conform accordingly while on a stretcher or gurney. This flexibility demonstrated in FIG. 8 shows why the removal of this application from under the patient isn't necessary until patient movement needs have been fulfilled or the application needs to be recovered by their users. As discussed previously, FIG. 8 shows one of the elevated positions of the stretcher that was detailed previously. This stretcher has the patients head elevated in a semi-fowlers position. This position is in between 45° and 90°.

FIG. 9 shows the removal operation of the center spline 14. FIG. 9 illustrates the user holding onto the center spline handle 18 and withdrawing the center spline 14 out from the alternating loopholes 16. This action illustrating the withdrawal of the center spline 14, unlocks the left side 10 from the right side 12. Once the center spline is fully withdrawn from the last loophole 16, the application is ready for removal from under the patient. This operation will need to be completed in order for complete separation of the left side 10 and the right side 12 to occur.

FIG. 10 illustrates the removal of the application from under the patient when removal is required. At this point, the center spline 14 has been completely withdrawn from all of the alternating loopholes 16. There is no need for the patient to turn or roll to or from one side or the other.

The left side 10 and/or right side 12 are held onto by the users ready for the application to be withdrawn from under the patient. FIG. 10 illustrates that the users are using the handgrip openings 20 to hold onto the flexible sewn in rubber tubing 22 to withdraw the application out from under the patient. With the appropriate pressure, the users simply withdraw the application out from the patient. The left side 10, the right side 12, and the center spline 14 are then gathered in a different location of choice for reassembly.

Reassembly of this application is done by placing the left side 10 and the right side 12 side by side with all of the loopholes 16 in a straight line in alternating fashion. The center spline 14 is simply pushed through every loophole 16 until the center spline handle 18 is up to the edge of the first loophole 16 as shown in FIG. 1a and FIG. 1b and the tip of the center spline 18 in seen past the last loophole 16.

### CONCLUSION, RAMIFICATIONS, AND SCOPE

Accordingly, the reader will see that this application of various embodiments can be used to transfer a patient from one location to another easily and conveniently. This application will provide a more reliable method than the previously discussed forms of patient transferring and have the ability to limit patient movement during the lift and transfer. This application will provide a more uniform lift of the patient, while possessing user friendly characteristics such as handgrip openings, a sewn in rubber tubing frame to hold onto and an overall lightweight construction. This application will provide a way to split the application into two parts that were adjoined by a removable center spline going through alternating loopholes from each side. This application will be made of flexible material that conforms and adapts to the position or contour of the device it is placed on and the contour of the patient's body while being transferred. Thus the reader will see that at least one embodiment of this application provides a more reliable, lightweight device that can be used by persons of all levels and aspects of the medical and healthcare field where they are involved in the movement of a patient.

While our above description contains many specificities, these should not be construed as limitations on the scope, but rather as an exemplification of one or more preferred embodiments thereof. Many other variations are possible for this application. For example, this application's dimensions may be changed in size either larger or smaller. This application may be made of different materials. This application may be made in a different shape or contour. This application may be made in different colors or pattern and textures. This application may be altered not to completely separate. The materials used in this application may be of different textures, colors, patterns or shape. Framing may also be made of other flexible material other than rubber tubing. Thus the scope of the embodiments should be determined by the appended claims and their legal equivalent, rather than by the examples given.

We claim:

1. A patient transferring device of the type comprising a body of material having two halves connected by a center spline going through loopholes on the medial edges and having a flexible frame on the lateral edges of said device.

2. The transferring device of claim 1 wherein said body of material of said two halves is comprised of flexible, water resistant fabric.

3. The transferring device of claim 1 wherein said body of material of said two halves is comprised of said loopholes along said medial edges.

4. The transferring device of claim 1 wherein said body of material of said two halves is comprised of said flexible frame on said lateral edges.

5. The transferring device of claim 4 wherein said flexible frame is comprised of said Flexible rubber tubing.

6. The transferring device of claim 5 wherein said flexible frame is comprised of said flexible rubber tubing that is sewn into said body of material of each said halves.

7. The transferring device of claim 1 wherein said body of material of said two halves has said handgrip openings along said lateral edges.

8. The transferring device of claim 1 wherein said body of material of said center spline is comprised of Low density polyethylene.

9. The transferring device of claim 1 wherein said body of material of said two halves and said center spline shall remain flexible.

10. A patient transferring device of the type comprising two pieces of fabric with a flexible frame sewn into one of the lateral edges on each half and loopholes on the medial edges of each said half with a center spline inserted through alternating said loopholes of each said halves forming a patient transferring device

11. The transferring device of claim 10 wherein said body of material of said two halves is comprised of flexible, water resistant fabric.

12. The transferring device of claim 10 wherein said body of material of said two halves is comprised of said loopholes along said medial edges.

13. The transferring device of claim 10 wherein said body of material of said two halves is comprised of said flexible frame on said lateral edges.

14. The transferring device of claim 13 wherein said flexible frame is comprised of said Flexible rubber tubing.

15. The transferring device of claim 14 wherein said flexible frame is comprised of said flexible rubber tubing that is sewn into said body of material of each said halves.

16. The transferring device of claim 10 wherein said body of material of said two halves has said handgrip openings along said lateral edges.

17. The transferring device of claim 10 wherein said body of material of said center spline is comprised of Low density polyethylene.

18. The transferring device of claim 10 wherein said body of material of said two halves and said center spline shall remain flexible.
